(19) United States
(12) Patent Application Publication
(10) Pub. No.: US 2010/0099057 A1
(43) Pub. Date: Apr. 22, 2010

(54) ROOT CANAL INSTRUMENT HANDLE MADE OF TWO CO-AXIAL PORTIONS JOINED IN AXIAL TRANSLATION AND IN ROTATION

(75) Inventors: Philippe Garcia, Bussieres (FR); Jacques Pernot, Vieilley (FR); Hubert Euvrard, Besancon (FR)

Correspondence Address: EGBERT LAW OFFICES, 412 MAIN STREET, 7TH FLOOR, HOUSTON, TX, 77002, US

(73) Assignee: Micro Mega International Manufactures (Societe Anonyme), Besancon (FR)

(21) Appl. No.: 12/531,300

(22) PCT Filed: Mar. 25, 2008
(86) PCT No.: PCT/FR08/50514

§ 371 Date: Sep. 14, 2009

(30) Foreign Application Priority Data
Apr. 12, 2007 (FR) 0754412

(51) Int. Cl. A61C 5/02

(52) U.S. Cl. 433/102

(57) ABSTRACT

The invention relates to a method for designing and producing a package intended for the protection and/or transportation of a product. All of the digital design steps for the package are integrated in the method for digitizing the product, which includes a step of laminating a virtual key form of the product used to define geometrical data of each layer of the package to be cut. Then, the cutting is carried out followed by the stacking of the layers of the package defined by the design steps for said package to form a real package. The invention also relates to the package obtained by the method.

### CROSS-REFERENCE TO RELATED U.S. APPLICATIONS

Not applicable.

STATEMENT REGARDING FEDERALLY SPONSORED RESEARCH OR DEVELOPMENT

Not applicable.

NAMES OF PARTIES TO A JOINT RESEARCH AGREEMENT

Not applicable.

REFERENCE TO AN APPENDIX SUBMITTED ON COMPACT DISC

Not applicable.

### BACKGROUND OF THE INVENTION

1. Field of the Invention

The present invention relates to a new type of handle for a root canal instrument.

2. Description of Related Art Including Information Disclosed Under 37 CFR 1.97 and 37 CFR 1.98

In the prior art, there is a known type of handle made from plastic material, which has the following advantages: a large number of available colors, easy cleaning, and electrical insulation. The known plastic handle has the following disadvantages: poor resistance to cleaning and disinfection products, poor resistance to sterilization, low torque transmission, and unattractiveness to some customers.

In the prior art, there is also a known type of metal handle, which has the following advantages: good resistance to cleaning and disinfection products, good resistance to sterilization, high torque transmission, attractiveness to customers, and good electrical conduction. The known metal handle has the following disadvantages: a small number of available colors, difficulty in cleaning because of the interface between the handle and the blade, the necessity of providing a different handle diameter for each wire diameter, and the fact that this diameter must be precise.

In the prior art there is a known document D1, FR 2 499 446 A, which describes a handle made from two coaxial parts, namely an inner part and an outer handle covering the inner part. The handle is retained and locked with respect to rotation in the handpiece head or contra angle by contact between a metal part of the head and the plastics handle, which can result in deformation of the handle at high torque levels.

### BRIEF SUMMARY OF THE INVENTION

The object of the present invention is to propose a new type of handle which has the principal advantages of both types of prior art handles, without having the disadvantages of either, and which resolves the problem of the handle of document D1.

This object is achieved by the invention, which is constituted by a handle for a root canal instrument of the rotary endodontic type, for example a reamer shank, which has, at its end intended for engagement in a drive assembly of a handpiece head, an annular groove and a flat for interaction with complementary axial connection and rotary connection means provided in the drive assembly. The handle is characterized in that it is made from two axial parts, namely an inner part and an outer part covering at least part of the length of the inner part, means being provided to fix the handle to the inner part with respect to both axial translation and rotation, and means for locking with respect to rotation and translation for interaction with a root canal instrument. The means for locking with respect to rotation are formed by projections of the handle, each having a lateral ridge which is placed in the plane of a flat which is parallel to the axis of the handle and which is provided at the end of the handle which is intended for engagement in a drive assembly.

The invention also relates to an assembly (a handle and a root canal instrument), characterized in that the handle is of the above type, and characterized in that the root canal instrument has an axial cut-out (1a) formed in the instrument by deformation or removal of material.

In order to facilitate the identification of an instrument, it is possible to make a combination of colors of the outer handle and of one or both ends of the inner part correspond to a given instrument.

### BRIEF DESCRIPTION OF THE SEVERAL VIEWS OF THE DRAWINGS

The invention will be made clearer by the following description, which refers to the following attached figures.

FIG. 1 is a schematic view of a handle according to the invention, in a first embodiment.

FIG. 2 is a longitudinal sectional view of the handle of FIG. 1.

FIG. 3 is a schematic view of a handle according to the invention, in a second embodiment.

FIG. 4 is a longitudinal sectional view of the handle of FIG. 3.

FIGS. 5, 6 and 7 are respective schematic, front and sectional views, the sectional view being taken through (AA) of an outer handle (2) of a handle according to the invention.

FIG. 8 is a sectional view of another alternate embodiment with a non-circular cross section.

### DETAILED DESCRIPTION OF THE INVENTION

The principle of a handle according to the invention is that it can be made from two coaxial parts, which are cylindrical for example, namely an inner part (3) and an outer handle (2) covering at least part of the length of the inner part, and means provided to fix the handle (2) to the inner part (3) with respect to both axial translation and rotation. Subject to manufacturing tolerances, the inside diameter of the handle is equal to the outside diameter of the inner part (3) over the length which is covered.

Clearly, the cross section of the handle is not necessarily cylindrical; for example, it is possible to consider the use of a polygonal cross section, or an interface cross section of polygonal shape between the sleeve (2) and the inner part (3), as in the example of FIG. 8.

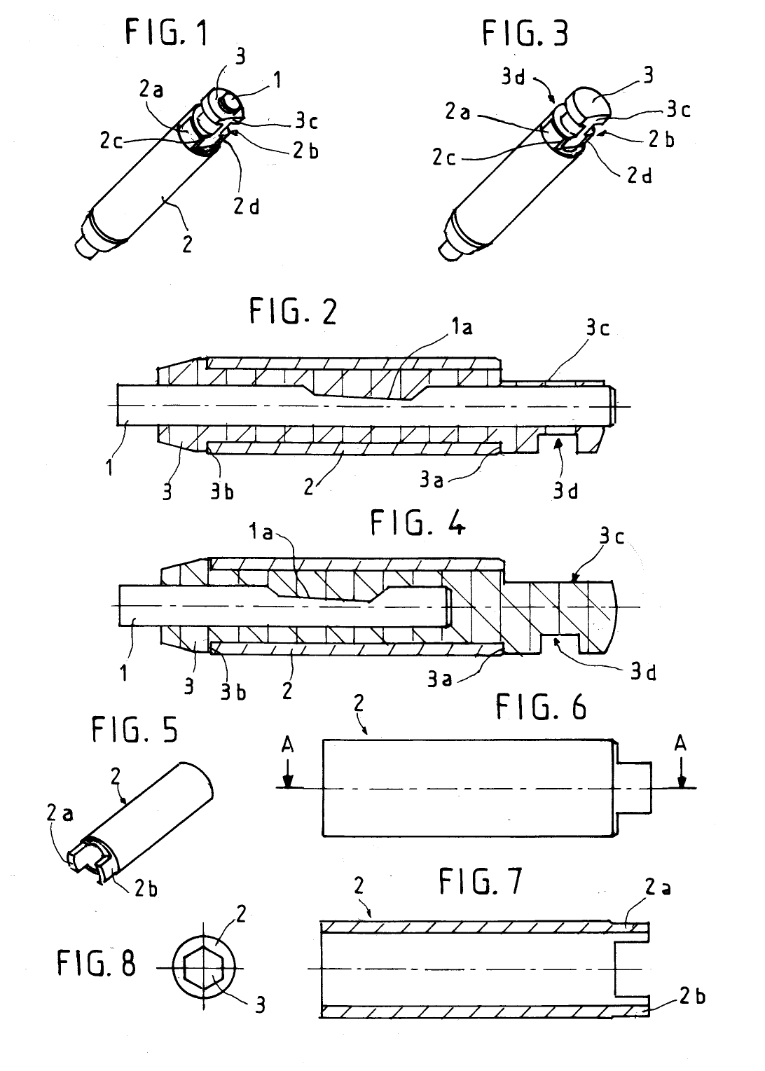

In the first variant embodiment shown in FIGS. 1 and 2, the handle according to the invention is mounted on an instrument or a blade (1) which passes through it from end to end. In the second variant embodiment shown in FIGS. 3 and 4, the handle is mounted on an instrument or a blade (1), which is embedded in the inner part (3).

The handle (2) can be made, for example but not exclusively, from metal, and can be colored or uncolored.

The inner part (3) can be made, for example but not exclusively, from plastics material.

The handle covers a central area of the inner part (3), over a predetermined length, and it is locked axially by shoulders (3a) and (3b) provided at the ends of the inner part (3), or by any equivalent means of locking with respect to translation.

Means for locking with respect to rotation are also provided, and can be formed for example, but not exclusively, by projections (2a, 2b), each having a lateral ridge (2c) or (2d) placed in the plane of a flat (3c) which is parallel to the axis of the handle and which is provided at the end of the handle intended for engagement in a drive assembly. The same end also has an annular groove (3d).

Preferably, the annular groove (3d) and the flat (3c) can conform to the ISO 1797 standard for dental instruments, thus enabling the handle to be engaged in the heads of handpieces and of contra angles conforming to this standard.

Means are also provided for fixing the inner part (3) to the blade (1) with respect to translation and rotation. For example, but not exclusively, an axial cut-out (1a) can be provided in the blade (1) of the root canal instrument, this cut-out being formed either by removal of material or by deformation (by simple crushing, for example) of said blade. The material of the inner part fills said cut-out at the time of molding.

It is also possible to consider forming the ends of the inner part (3) from plastics materials of different kinds and/or colors, and making the shapes of the shoulders (3a, 3b) different.

Examples of the advantages of the handle according to the invention are as follows:
numerous color combinations between the inner part and the handle, for the identification of the instruments;
easy cleaning;
a single handle diameter for all wire diameters;
high resistance to cleaning and disinfection products;
high resistance to sterilization;
high torque transmission;
attractiveness to customers;
good conduction of electrical current, which flows through the handle only, without any diffusion through the handle, which is insulating;
suitable for the use of apex locators incorporated in contra angles;
all the advantages of the invention being obtained without any increase in price, but rather with a decrease in the production cost.

I claim:

1. Handle for a root canal instrument of a rotary endodontic type, the instrument having an end engaging a drive assembly of a handpiece head or a contra angle, an annular groove and a flat for interaction with complementary axial connection and rotary connection means provided in the drive assembly, having the instrument passing through from end to end and comprising:
two axial parts, namely an inner part and an outer handle covering at least part of the length of the inner part,
means being provided to fix the handle to the inner part with respect to both axial translation and rotation, and
means for locking with respect to rotation and translation, for interaction with a root canal instrument, the means for locking with respect to rotation being formed by projections of the handle, each having a lateral ridge placed in a plane of a flat, said flat being parallel to the axis of the handle and which is provided at the end of the handle which is intended for engagement in a drive assembly.

2. Handle according to claim 1, wherein said handle is comprised of metal.

3. Handle according to claim 1, wherein said inner part is comprised of plastics material.

4. Handle according to claim 1, wherein the handle covers a central area of the inner part, over a predetermined length, and being axially locked by shoulders provided at the ends of the inner part.

5. Handle according to claim 1, being fixed to a root canal instrument by means for locking with respect to translation and rotation, said means being provided by interaction of the material of the inner part with the instrument.

6. Assembly comprising:
a handle defined in claim 1; and
a root canal instrument having an axial cut-out formed in the instrument by deformation or by removal of material.

7. Assembly according to claim 5, wherein a given combination of colors of the inner part and of the outer sleeve corresponds to a given instrument.
